(19) United States
(12) Patent Application Publication
(10) Pub. No.: US 2010/0303956 A1
(43) Pub. Date: Dec. 2, 2010

(54) Crispy Bread Product And Method For Making Same

(76) Inventors: Kathryn Hupfer, Chicago, IL (US); Nicole L. Windsor, Highland Park, IL (US); James C. Studtmann, Buffalo Grove, IL (US); Yayu Sophia Pai, Lombard, IL (US); Ellen M. Drewett, Chicago, IL (US); Daniel Reyes, Elmhurst, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/475,192

(22) Filed: May 29, 2009

(51) Int. Cl. A21D 13/00; A21D 15/02; A21D 8/00

(52) U.S. Cl. 426/19; 426/551; 426/95

(57) ABSTRACT

An improved dough composition is provided which can be used to prepare a frozen thin crust bread product. The frozen bread product can be heated in a microwave oven to provide a cooked thin crust bread product having a crispy bottom surface. Methods of preparing the same are also provided.

### FIELD

This disclosure relates to an improved crispy bread product. More particularly, this disclosure relates to improved dough for making a crispy pizza product having a crispy bottom surface and a method for making the same. The dough is especially useful for preparing a fully baked or par baked thin crust pizza product with various toppings that can then be prepared in a microwave oven from the frozen state in only a short amount of time.

### BACKGROUND

Convenience foods (i.e., products which require a minimum amount of consumer preparation and are quick to prepare) are in high demand to accommodate today's busy lifestyles. Examples range from cheese and cracker snacks and refrigerated bagels to frozen dinners. Typically, such products can be eaten as packaged or after a brief heating period in a microwave or microwave oven.

Baked bread products are normally available as freshly prepared products that are intended to be consumed within a relatively short time period or as frozen products which can be stored in the frozen state for relatively long periods of time and then thawed for consumption. Examples of such frozen bread products include frozen pizzas and flatbreads which are then heated in a conventional or microwave oven. Today's standards for reheatable frozen bread products, such as pizza crusts and flatbreads, are high. The marketplace desires, if not expects, reheatable frozen bread products that rival bread products made in a conventional or masonry oven in both texture and taste. Attempts to prepare thin crust, conventionally-sized frozen bread products having toppings have generally not been successful. The problems associated with frozen thin crust products include, for example, (1) moisture migration from the sauce or toppings into the crust, thus resulting in the cooked bread product having less than the desired amount of crispiness; (2) crust that is too thin to support the weight of the toppings; (3) lack of flavor and pleasant mouthfeel characteristic of thicker crust products; and (4) unacceptably chewy texture upon reheating.

### SUMMARY

This disclosure relates to frozen fully baked or par baked thin crust bread products which, when heated in a microwave oven, have a desirable crispy bottom surface. Generally the bread products of the present invention are generally of the flatbread or pizza crust type and can be prepared with or without toppings. The bread products described herein have a crispy bottom surface that is more “cracker-like” and rigid than conventional microwaved thin crust bread products, which typically have a chewy and flexible crust. Advantageously, the bread product described herein has a crispiness and rigidity sufficient to support the weight of conventional pizza toppings after cooking in a microwave oven for only a short time, whereas conventional thin crust bread products have a weak crust that is generally unable to support the weight of conventional pizza toppings. The bread products described herein have a crispy bottom surface. It was surprisingly found that a cracker-like crust could be achieved in a microwavable thin crust formulation, i.e., less than about 12 mm thick, preferably about 2 to about 10 mm thick, more preferably about 4 mm to about 8 mm thick, and most preferably about 6 to about 7 mm thick, while also providing the desired rigidity after cooking in a microwave oven.

Preferably, the frozen bread product described herein is heated in a microwave oven to provide a crispy bottom crust. Preferably, the frozen bread product will have one or more toppings on the upper exterior surface of the bread product. The toppings can be, and preferably are, placed on the upper exterior surface during manufacture and are frozen in place on the bread product so that the consumer can simply open the package, place it in a microwave oven, and prepare the final product without additional steps. The frozen bread product can also be supplied without toppings; consumers can then prepare the bread product with or without toppings as they desire. For purposes herein, “bread” product, “flatbread-type bread” products, or bread products of the “flatbread type” refer to fully-baked or par-baked thin bread products having a thickness of less than about 12 mm, such as, for example, flatbread, pizza crust, and the like.

For purposes herein, “bottom surface” or “bottom exterior surface” refers to the surface of the bread product which is in contact with a susceptor cooking surface when cooked in a microwave oven. Likewise, the “top surface” or “top exterior surface” is opposite the bottom surface and can receive the desired topping or toppings. And the “interior portion” refers to the bread product between the top and bottom surfaces and essentially defines the thickness of the bread product. Of course, the bread product may have an outside rim which may be thicker than the thickness of the bread product.

The dough formulation described herein provides a bread product, preferably a thin pizza crust, having a crispy bottom surface upon cooking in a microwave oven. Preferably, this pizza crust also has a crispy rim around the outer circumference or the “flat” dimension of the crust. The bottom surface of the bread product of the invention is more “cracker-like” and inflexible than conventional thin crust bread products, which typically have a chewy and flexible crust. The crust has a generally uniform golden brown color after cooking in a microwave oven on a susceptor. The rim of the bread product of the invention is at least as crispy as the bottom surface and, generally, is substantially crispier than the bottom surface. For example, the rim will tend to “snap” when bent by the consumer, whereas the bottom surface will generally break more like a cracker without the “snap.”

The dough contains, in baker's percentages, 100 percent dough, about 50 to about 60 percent water, about 1.0 to about 7.0 percent leavening agent, about 0.5 to about 8 percent oil, and about 2.0 to about 8.0 percent fat flakes wherein the dough contains about 9 to about 12 percent protein, wherein the leavening agent comprises yeast, encapsulated chemical leavening base, and leavening acid, and wherein the fat flakes have a thickness of about 0.5 to about 4 mm, although flakes having a smaller thickness (e.g., about 0.5 to about 1.5 mm) should be used for bread products having a thickness of less than about 4 mm. Preferably, the leavening agent comprises about 0.5 to about 5 percent compressed yeast, 0.25 to about 1.0 percent encapsulated chemical leavening base, and 0.25 to about 1.0 percent leavening acid. The dough can be formed into the desired shape to form a thin crust type product wherein the flat flakes are uniformly distributed throughout the formed dough product.

It has surprisingly been found that the dough product of the above formulation provides a fully baked or par baked thin crust bread product having a crispier crust as compared to conventional thin crust bread products.

Suitable leavening agents include yeast (e.g., dry yeast, compressed yeast), encapsulated chemical leavening base (e.g., encapsulated sodium bicarbonate, encapsulated ammonium bicarbonate, encapsulated calcium bicarbonate, and the like), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone, and the like), mixtures thereof, and the like. Other organic acids suitable for baking may also be used, if desired, such as fumaric acid, lactic acid, tartaric acid, malic acid, citric acid, and the like. Preferably, a combination of compressed yeast, encapsulated sodium bicarbonate, and sodium aluminum phosphate is used as the leavening agent.

The disclosure also includes methods for making the baked or par-baked bread products using this bread dough for later heating in microwave ovens. One such method comprises (a) mixing dough ingredients comprising, in baker's percentages, 100 percent flour, about 50 to about 60 percent water, about 1.0 to about 7 percent leavening agent, about 0.5 to about 8 percent oil, and about 2.0 to about 8.0 percent fat flakes, wherein the dough contains less than about 12 percent protein, wherein the leavening agent comprises yeast, encapsulated chemical leavening base, and leavening acid, and wherein the fat flakes have a thickness of about 0.5 to about 4 mm; (b) resting the dough, such as for about 5 to about 10 minutes; (c) cutting the dough to the desired weight; (d) proofing the dough, such as at about 80 to about 110° F. for about 10 to about 60 minutes at a relative humidity of about 75 to about 95 percent; (e) pressing to shape the dough; and (f) baking the dough to form a fully baked or par-baked bread product. The conditions under which the fat flakes are incorporated into the dough should be adjusted so that the appropriately sized fat flakes are contained in the dough prior to the initial baking step. The baked or par-baked bread product may then be topped with one or more toppings, if desired, and frozen. Alternatively, the fully baked or par-baked product may first be frozen, the toppings added, and the total product frozen. Preferably, the flour, leavening agent, oil, water, and any optional ingredients are mixed together first and then the fat flakes are incorporated therein; this allows more precise control over mixing conditions, and thus the particle size of the fat flakes, within the dough as well as avoiding damaging the fat flakes. Mixing should be controlled so that the fat flakes are of the desired size in the dough and are distributed uniformly through the dough.

If a particularly crispy crust is desired, the baking temperature and length of time of the baking step can be increased. The crispiness of the final product can also be enhanced during manufacture of the crust by flipping the crust (i.e., 180 degrees) after baking such that the toppings are placed on the side of the crust that was the bottom of the crust during baking.

In one aspect, the bread product is prepared in the form of a multi-serve pizza crust, and the dimensions of the pizza crust are selected to fit within most standard sized microwaves while still providing the desired organoleptic properties after baking. The bread products as described herein can be up to about 10 inches in diameter (i.e., multi-serve sized pizzas) and still provide the desired crispy texture to the crust and cooking, but not overcooking, conventional pizza toppings on the crust. Generally, such larger multi-serve sized pizzas as provided herein can be cooked on a susceptor in a microwave oven in about 5 to about 9 minutes.

In another aspect, the bread product has a low mass to surface area ratio to allow for rapid cooking and superior crisping in the microwave. For example, a bread product having a mass of about 75 to about 125 grams and a total surface area of about 18 to about 25 inches can be cooked on a microwave susceptor to achieve desired crispiness and a surface temperature of at least about 165° F. in about 1.5 minutes to about 3.0 minutes. The bread product has superior crisping as compared to prior art bread products having higher mass to surface area ratios.

Crispiness can be quantified as the force required to penetrate the crust, such as using a TA-XT2 Texture Analyzer from Texture Technologies Corporation (Scarsdale, N.Y.). In one aspect, the average force to penetrate the edge of the crust of the bread products described herein is at least about 220 grams. In another aspect, the average force to penetrate the edge of the crust of the bread products described herein is at least about 290 grams. In another aspect, the average force to penetrate the edge of the crust of the bread products described herein is at least about 360 grams. In another aspect, the average force to penetrate center of the crust of the bread products described herein is at least about 195 grams. In another aspect, the average force to penetrate center of the crust of the bread products described herein is at least about 380 grams. In another aspect, the average force to penetrate center of the crust of the bread products described herein is at least about 485 grams.

In another aspect, the bread product can be prepared with full calorie and full fat ingredients and still provide a lower caloric content per serving due to increased surface area of the bread product. The caloric content to surface area ratio is calculated by dividing the total number of calories (including any toppings) by the surface area of the product. Preferably, the bread products as described herein have a ratio of calories to surface area of about 9.5 or less, more preferably about 8.5 or less when surface area is measured in inches, or about 2.0 or less, more preferably about 1.75 or less when surface area is measured in centimeters. Bread products provided with a thin crust (i.e., less than about 12 mm, preferably about 2 to about 10 mm) allows for less mass per unit of surface area which also provides for lower caloric content per unit of surface area.

If desired, the frozen bread product described herein may include a variety of toppings, such as, but not limited to, meat, cheeses, vegetables, tofu, soy, soy derivatives, sauces, dressings, spreads, gravies, condiments, spices, herbs, flavorings, colorants, and the like, as well as mixtures thereof.

In one preferred form, the bread product is a frozen pizza crust that, when heated in a microwave oven provides a thin pizza crust that can be baked in a microwave oven to provide a thin crust pizza having a crispy bottom surface.

### BRIEF DESCRIPTION OF THE DRAWINGS

FIG. 1 provides a side view of a bread product after fully baking or par-baking with a topping on the upper bread surface.

FIG. 2(A) illustrates the rigidity of a slice of the thin pizza crust of the invention as compared to a slice of conventional thin crust pizza, shown in FIG. 2(B), when held by hand for consuming.

FIG. 3 provides a general flow chart illustrating a general method for the preparation of a fully assembled frozen flatbread product of the invention.

FIG. 4 provides a side view of the dough after being formed into the desired shape (i.e., thin crust) with the fat flakes distributed throughout the thickness of the crust prior to fully baking or par-baking.

FIG. 5(A) illustrates hole pattern #1 and FIG. 5(B) illustrates hole pattern #2 as used in the trays and/or susceptors of the Example.

Those skilled in the art will appreciate that elements in the figures are illustrated for simplicity and clarity and are not drawn to scale. For example, the dimensions and/or relative positioning of some of the elements in the figures may be exaggerated relative to other elements to help to improve understanding of various embodiments of the invention. Also, common but well-understood elements that are useful or necessary in a commercially feasible embodiment are often not depicted in order to facilitate a less obstructed view of these various embodiments of the invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

This disclosure relates to an improved dough and frozen bread product, preferably a thin flatbread product, such as a pizza crust, flatbread, and the like. Such bread products, when heated in a microwave oven, have a crispy bottom surface. The bread products described herein have a crispy bottom surface that is more “cracker-like” and inflexible than conventional microwaved thin crust bread products, which typically have a chewy and flexible crust. Advantageously, the bread product described herein has a crispiness and rigidity sufficient to support the weight of conventional pizza toppings after baking whereas conventional bread products have a weak crust unable to support the weight of conventional pizza toppings. It was surprisingly found that a crispy, thin crust bread product, i.e., less than about 12 mm thick, preferably about 2 to about 10 mm thick, more preferably about 4 mm to about 8 mm thick, and most preferably about 6 to about 7 mm thick, could be achieved while also providing the desired rigidity after cooking in a microwave oven. If desired, the bread product may include toppings on the upper surface. This disclosure further relates to method of making the dough and frozen bread products.

For purposes herein, “bottom surface” or “bottom exterior surface” refers to the surface of the bread product which is in contact with a susceptor when cooked in a microwave oven. Likewise, the “top surface” or “top exterior surface” is opposite the bottom surface and can receive the desired topping or toppings. And the “interior portion” refers to the bread product between the top and bottom surfaces and essentially defines the thickness of the bread product. Of course, the bread product may have an outside rim which may be thicker than the thickness of the bread product.

The bread formulations of this disclosure are designed to provide good organoleptic properties and a crisp bottom layer after baking in a microwave oven by the consumer. Thus, the bread formulations provided herein have better organoleptic properties as compared to similar products prepared with conventional dough formulations, including conventional dough formulations used in thin bread products currently available in the marketplace. Although the dough formulations described herein are especially designed for use in thin pizza crusts, the dough formulations can be used to advantage in other bread products intended to be heated in microwave ovens, such as flatbread products.

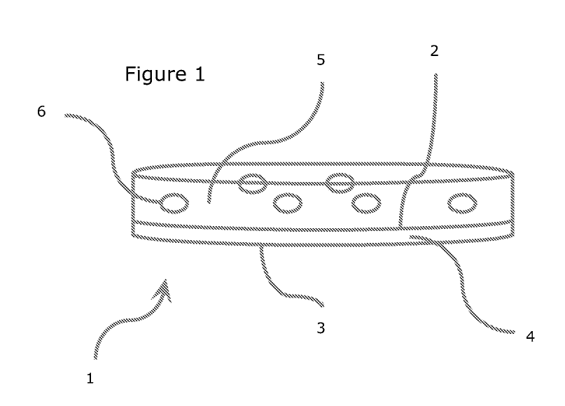

FIG. 1 illustrates a fully assembled frozen bread product 1 having an upper surface 2, a bottom surface or base 3, an interior portion 4, and topping 5. Topping 5 may be provided on the upper surface 2 of the bread product 1. In one aspect, the bread product 1 may include a topping 5, which may include, if desired, meat or vegetables in the form of chunks, lumps, or diced shapes 6. The topping may be substantially coextensive with the upper surface 2 (as illustrated) but is not required. Alternatively, the bread product may have a rim, which preferably has a greater thickness than the bottom surface or base of the bread product. In a preferred aspect, the bread product is cooked in a microwave oven and the bottom surface 3 becomes crispy during heating.

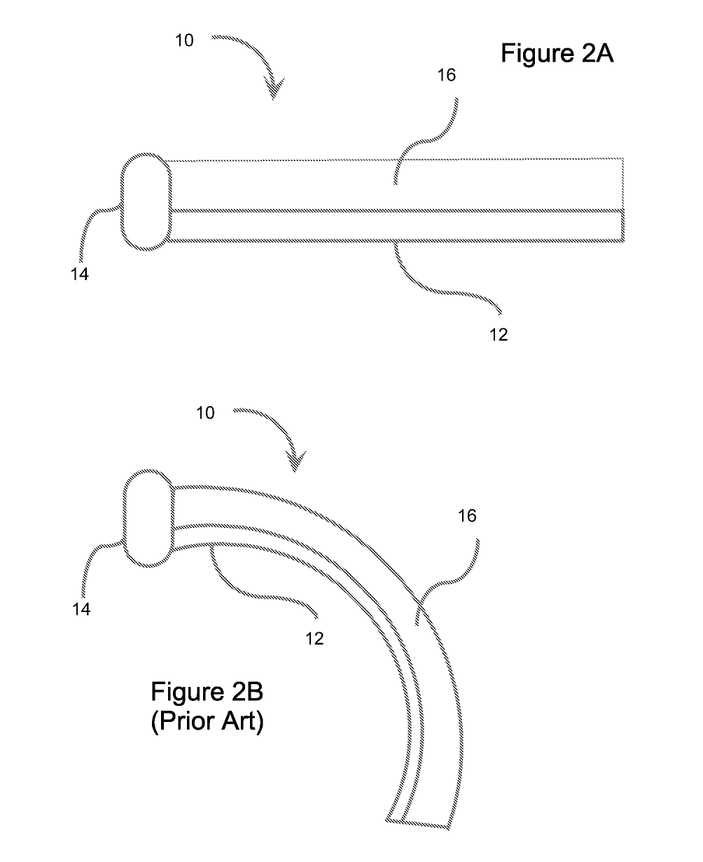

Moreover, the crispy, but not hard or tough, bottom crust of the bread product provides sufficient support to withstand the weight of conventional pizza toppings. As shown in FIG. 2(A), the bread product of the invention, shown as a pizza crust 10 with bottom surface 12 (e.g., base), rim 14, and toppings 16, can be picked by rim 14 of the crust without the bottom surface of the pizza bending or breaking under the weight of the toppings 16. FIG. 2(B) depicts a conventional microwaved thin crust pizza, the crust of which is unable to support the weight of the toppings. The bottom surface of the bread product of the invention is more “cracker-like” and inflexible than conventional thin crust bread products, which typically have a chewy and flexible crust. The rim of the bread product of the invention is at least as crispy as the bottom surface and, generally, is substantially crispier than the bottom surface. For example, the rim will tend to “snap” when bent by the consumer, whereas the bottom surface will generally break more like a cracker without the “snap.”

Dough Formulation. The following descriptions refer to preparation and use of bread dough for purposes of the provided non-limiting illustrations, but it will be appreciated that the concepts of the disclosure are considered to be generally applicable to a variety of fully-baked or par-baked thin bread products, including flatbread, pizza crust, and the like.

The bread dough described herein comprises a unique formulation that, when combined with particular product configurations, provides the desirable crispy bottom surface upon heating in a microwave oven for only a short amount of time. The bread dough comprises a leavened mixture comprising a major portion of flour and water and a minor portion of fat flakes and oil. The bread dough may be yeast and/or chemically leavened, although the leavening agent comprises both compressed yeast and chemical leavening agents (i.e., encapsulated chemical leavening base and leavening acid).

It should be noted that the percentages used to describe the dough product are baker's percentages, which are weight percentages based on the weight of flour used in a specific recipe (generally per 100 pounds of flour). For example, for 100 pounds of flour in a recipe, 55 percent water and 0.5 percent compressed yeast would mean the addition of 55 pounds of water and 0.5 pounds of yeast to 100 pounds of flour. Of course, such baker's percentages do not add up to 100 percent. Conventional percentages can be calculated from baker's percentages by normalizing to 10 percent.

An illustrative and preferred recipe (in baker's percentages) for dough prepared according to an embodiment of the invention is provided in the table below.

| | Illustrative Recipe | Preferred Recipe |
|---|---|---|
| Ingredient | (% flour basis) | (% flour basis) |
| Flour | 100 | 100 |
| Compressed yeast | 0.5-5 | 3-5 |
| (liquid yeast) | (2-8) | (5-7) |
| Encapsulated chemical | 0.25-1.0 | 0.5-0.95 |
| leavening base | | |
| Leavening acid | 0.25-1.0 | 0.5-0.95 |
| Salt | 0-4.0 | 1-3 |
| Sweetener | 0-6.0 | 0.5-1.5 |
| Fat flakes | 2.0-8.0 | 4-6 |
| Water | 50-60 | 55-60 |
| | | (51-55 when liquid |
| | | yeast used) |
| Oil | 0.5-8.0 | 3-5 |

The fat flakes (i.e., shortening flakes) useful herein have a generally flat, planar shape. Fat flakes used in the present invention can be regularly shaped particles or irregularly shaped particles; the actual shape of these fat flakes does not appear to be especially important. However, many other factors are involved in successfully incorporating fat flakes into the dough formulation, including the size of the fat flakes, the solid fat content of the fat flakes, the temperature of the dough, the mixing speed, and mixing time. The solid fat content of the fat flakes affects how easily the flakes are damaged during mixing (e.g., lose their “flake” shape, melt, break up, disintegrate, or the like). Generally, fat flakes having lower solid fat content are more delicate and require lower mixing speeds, shorter mixing times, and/or lower dough temperatures during mixing to reduce damage to and/or melting of the fat flakes. Therefore, the mixing speed, the mixing time, and/or dough temperature during mixing should be selected in view of the solid fat content of the fat flakes and the starting size of the fat flakes and in view of the target size of the fat flakes after mixing and before baking.

Preferably, the fat flakes used herein are relatively firm solids at 80° F. (e.g., as determined by the solid fat content (“SFC”) and a pressure test). The fat flakes should have a solid fat content of about 45 to about 65 percent at 80° F., preferably about 50 to about 60 percent, and most preferably 55 percent. The fat flakes are also subjected to a pressure test to determine suitability for use in the formulation. Generally, the pressure test is performed by holding and squeezing the flake between the thumb and index finger with gentle pressure (e.g., slightly more pressure than is needed to prevent dropping the flake) for about 5 to about 10 seconds. Flakes with suitable firmness soften slightly but generally retain the flake shape upon application of such gentle pressure. Flakes that are unsuitable impart a sticky residue to the fingers and deform under such pressure.

The flat flakes have a generally flat, planar shape with a thickness of about 0.5 to about 4 mm. The thickness of the flakes should be less than the thickness of the bread product. Flakes of different thicknesses can be used depending on the desired thickness of the bread product. For example, for a crust having a thickness of about 5 mm, the fat flakes can range in thickness of about 0.5 to about 4 mm, while thinner fat flakes, such as about 0.5 to about 1.5 mm thick, should be used for a bread product having a crust of about 3 mm.

The fat flakes can be regular or irregular in shape so long as the desired thickness is obtained. Larger fat flakes may be added to the dough so long as the size of the fat flakes is reduced during mixing or the fat flakes distributed within the dough are of a size that allows formation of a layered structure within the fully baked or par baked bread products of this invention. Although not critical, the length and/or width of the fat flakes after mixing is generally about 2 mm to about 20 mm, preferably about 3 to about 7 mm. For example, if the particular fat flakes selected are of the size desired after mixing, the dough temperature can be selected so as to prevent melting of the fat flakes during mixing and/or the mixing speed and time can be selected so as to substantially reduce the amount of damage caused to the fat flakes. Alternatively, if the particular fat flakes selected are larger than the size desired after mixing, more intense mixing conditions and/or higher temperatures of the dough may be necessary to break-up and reduce the size of the fat flakes. Fat flakes that are too small or melt during mixing provide a dough mass having a generally homogenously distributed liquid fat content. Instead, the dough should include fat flakes dispersed within the dough which melt during baking. As noted above, initial size and firmness of the fat flakes and the mixing conditions can be adjusted to provide a dough having properly sized fat flakes uniformly distributed within the dough.

Suitable leavening agents include yeast (e.g., dry yeast, compressed yeast, cream yeast), encapsulated chemical leavening base (e.g., encapsulated sodium bicarbonate, encapsulated ammonium bicarbonate, encapsulated calcium bicarbonate), leavening acid (e.g., sodium aluminum phosphate, monocalcium phosphate anhydrous or monohydrate, sodium acid pyrophosphate, sodium aluminum sulfate, monopotassium tartrate, dicalcium phosphate dihydrate, glucono-delta-lactone), mixtures thereof, and the like. Other organics acids suitable for baking may also be used, such as fumaric acid, lactic acid, tartaric acid, malic acid, citric acid, and the like. Preferably, a combination of compressed yeast, encapsulated chemical leavening base, and leavening acid is used. More preferably, compressed yeast, encapsulated sodium bicarbonate, and sodium aluminum phosphate are used as the leavening agent. It was surprisingly found that using a leavening agent comprising compressed yeast, encapsulated chemical leavening base, and acid leavening agent provided a bread product, which upon baking in a microwave oven, has a crispier outer layer than a similar bread product where either the compressed yeast or encapsulated chemical leavening base (with leavening acid) was used without the other. Generally, a bread product made with compressed yeast but without chemical leavening agent provides a slightly denser product. A bread product made with encapsulated chemical leavening base and leavening acid but without compressed yeast lacks desired flavor. Therefore, it is preferable that the leavening agent comprises a combination of compressed yeast, encapsulated chemical leavening base, and compressed yeast, such as about 0.5 to about 5 percent compressed yeast, 0.25 to about 1.0 percent chemical leavening agent, and about 0.25 to about 1 percent leavening acid are used; preferably about 1 to about 4 percent compressed yeast, about 0.5 to about 0.95 percent chemical leavening base, and about 0.5 to about 0.95 percent leavening acid are used. Dry yeast or liquid yeast may be substituted for the compressed yeast. If dry yeast is used, the baker's percentage or weight is adjusted to account for the water content of the compressed yeast; likewise, if liquid yeast is used, the baker's percentage or weight is adjusted to account for the water content of the liquid yeast.

Exemplary of the flour component or farinaceous materials which may be used, for example, are whole grain or refined wheat flour. Hard or soft wheat flours, red or white wheat flours, winter or spring, and blends thereof, all purpose flours, and so forth may be used. The flour may be bleached or unbleached. Wheat flour or mixtures of wheat flour with other grain flours are preferred. Low protein flours (e.g., about 9 to about 10 percent protein) may also be used if desired. Flours having a protein content of less than about 9 percent generally do not provide the functionality (e.g., elasticity) desired in the resulting dough product. Generally, it is preferable to use flour having about 9 to about 12 percent protein, preferably about 10 to about 11 percent protein. Flour having a high protein content (e.g., more than about 12 percent protein) should generally not be used as the high protein content contributes to an undesirable chewy texture in the final bread product. Non-wheat flours, such as soy flour, rice flour, corn flour, and the like, may be used, if desired, in combination with wheat flour to dilute the protein content of the wheat flour.

The bread dough also may contain minor amounts of other functional and flavoring additives commonly used in bread dough, such as oil, protein source, sweetener, preservative, emulsifier, salt, dough conditioners, chemical leavening agent, herbs, seasonings, spices, and the like, as long as the additional ingredients do not adversely affect formation of the product with the crispy bottom. If desired, the dough can be fortified with macronutrients and/or micronutrients, such as iron preparations, bioavailable calcium sources, vitamins, minerals, amino acids, and other nutraceuticals. Vitamin and vitamin-like nutritional fortification can be obtained using Vitamin C, Vitamin E sources, Vitamin D sources, beta carotene sources, and so forth.

Suitable oils include vegetable oils, shortening, hydrogenated oil, and the like. Preferred vegetable oils are corn, canola, olive, sunflower seed, cottonseed and soybean oils, or mixtures thereof, with soybean oil and corn oil being the most preferred. Other edible oils may also be used. A single edible oil or mixtures of such edible oils may be used. The oil may have a butter flavoring agent. Fat substitutes may also be used, if desired. Alternatively, a butter flavoring agent or other flavoring agent may be added to the recipe in an amount known to those skilled in the art or in accordance with the flavor manufacturer's recommendations.

The dough also may include sweeteners. These include sugars such as sucrose, fructose, glucose, high fructose corn syrup, or other sweet mono- or disaccharides commonly used in baking materials. The total sugar solids content of the dough of the present invention may range from 0 up to about 6 percent by weight, depending on the product. For bread dough, the total sugar content generally may range between 0 to about 6 percent by weight, preferably between about 0.5 to about 1.5 percent. All or a portion of the natural sweetener content can be substituted by or augmented with artificial sweetener, nonnutritive sweetener, high intensity sweetener, sugar alcohol materials, and the like. Of course, if used, the levels of such other sweeteners should be adjusted to provide the desired level of sweetness and, if appropriate (i.e., if corn syrup is used), the level of water may be adjusted to account for water added with the sweetener.

Since the baked or par baked bread of this invention will generally be distributed in a frozen form, preservatives may not be required. Nevertheless, the dough of the disclosure may include antimycotics or preservatives, such as calcium propionate, potassium sorbate, sorbic acid, sodium benzoate, nisin, and the like, singly or in combinations thereof, if desired. Exemplary amounts may range up to about 1 percent by weight of the dough, to assure microbial shelf-stability.

Flavorings and/or spices may be used in the manufacture of the flatbread dough, if desired. The flavorings may include, for example, olive oil, rosemary, garlic, butter, salt and the like. Other flavorings or combinations of flavorings may be used, if desired.

Optionally, breadcrumbs or cornmeal may be applied to the bottom surface of the dough product before baking. If used, the breadcrumbs are preferably Japanese breadcrumbs (e.g., Panko breadcrumbs), which have an airier texture than Western breadcrumbs. Addition of breadcrumbs or cornmeal to the bottom surface of the dough product can provide additional crispiness to the bottom surface after baking. The breadcrumbs or cornmeal can be added to the bottom surface using any conventional method, such as, for example, rolling or extruding the dough onto the breadcrumbs or cornmeal.

The bread formulations of this disclosure are designed to provide good organoleptic properties and a crisp bottom layer after baking in a microwave oven by the consumer. Thus, the bread formulations provided herein have better organoleptic properties as compared to similar products prepared with conventional dough formulations, including conventional dough formulations used in thin bread products currently available in the marketplace. Although the dough formulations described herein are especially designed for use in thin pizza crusts, the dough formulations can be used to advantage in other bread products, including those intended to be heated in microwave ovens, such as flatbreads.

Dough Mixing and Dough Products. The dough formulations of the disclosure can be formed into a useful bread product using a variety of techniques. The dough is mixed, rested, shaped, proofed, and baked before freezing. The bread product may be topped before or after freezing, if desired. The sequence of the other operations is not particularly limited and may be varied. It is important, as noted above, that the initial size and hardness of the fat flakes, as well as the conditions under which they are incorporated into the dough, be adjusted to obtain the desired size and homogenous distribution of the fat flakes in the dough before baking so that the desired textural characteristics are obtained.

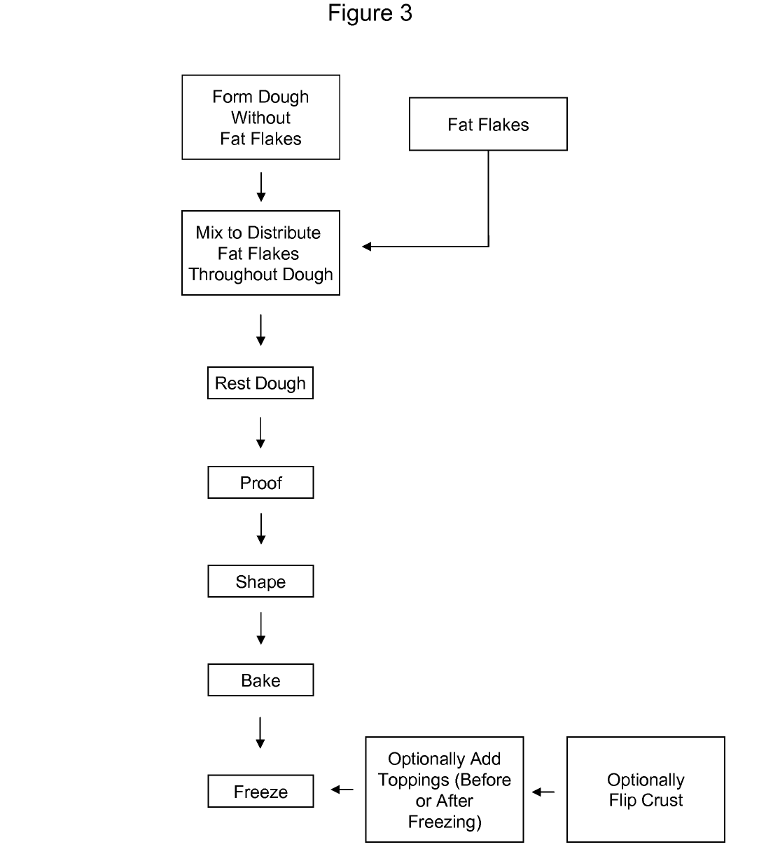

FIG. 3 illustrates a preferred general method of preparing fully assembled frozen bread products of the disclosure. As those skilled in the art will recognize, the order of steps shown in FIG. 3 can be modified if desired; for example, freezing can occur before or after adding a topping. The dough is first prepared by mixing dough ingredients comprising, in baker's percentages, 100 percent flour, about 50 to about 60 percent water, about 1.0 to about 7 percent leavening agent, and about 2.0 to about 8.0 percent fat flakes. Other ingredients may be added if desired. Preferably, the flour, leavening agent, oil, water, and any optional ingredients are mixed prior to the addition of the fat flakes in order to allow better control of the size and distribution of the fat flakes in the dough.

The fat flakes are added and mixed under conditions to provide the desired size and distribution of the fat flakes in the dough. The mixing speed, the mixing time, and/or dough temperature during mixing should be selected in view of the solid fat content of the fat flakes and the starting size of the fat flakes to achieve the desired size and distribution of the fat flakes after mixing and before baking. For example, if the particular fat flakes selected are close to the size desired after mixing, the dough temperature can be selected so as to prevent melting of the fat flakes during mixing and/or the mixing speed and time can be selected so as not to substantially reduce the size of the fat flakes or otherwise damage them. Alternatively, if the particular fat flakes selected are larger than the size desired after mixing, mixing conditions can be modified to achieve the desired size and distribution of the fat flakes in the dough prior to baking.

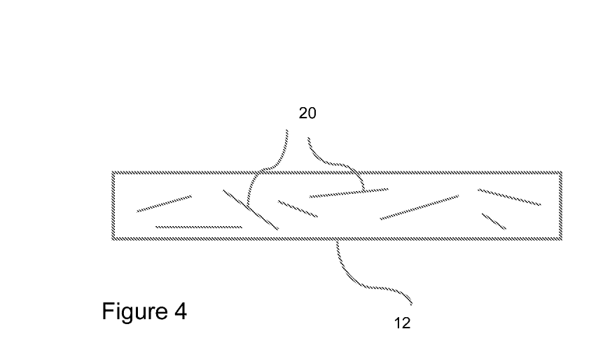

As depicted in FIG. 4, fat flakes 20 are dispersed heterogeneously in dough 12. It has surprisingly been found that the dough product of the above formulation provides a microwaved thin crust bread product having a crispier crust as compared to conventional microwaved thin crust bread products. The formulation of the bread product provides for an uneven cell structure in the crust. It is believed that the uneven cell structure of the bread products described herein is attributable, at least in part, to the combination of the crust size, the inclusion of generally planar fat flakes (i.e., shortening flakes) of a particular size, thickness, firmness, and solid fat content at 80° F., and the use of a microwave susceptor to cook the bread product in a microwave oven. Generally, otherwise similar baked products prepared without fat flakes or with a lesser amount of fat flakes are denser with a chewier texture.

The resulting dough mixture is rested for about 1 to about 10 minutes and then, if necessary, cut to the desired weight. The dough is then proofed, such as at about 80 to about 110° F. for about 10 to about 60 minutes, preferably about 10 to about 25 minutes, at a relative humidity of about 75 to about 95 percent. The proofed dough is then shaped, such as by pressing, to desired thickness and/or shape and then baked to form a fully baked or par-baked bread product.

Optionally, if a particularly crispy crust is desired, the baking temperature and length of time of the baking step during manufacture may be increased. Optionally, the crispiness of the final product can also be further enhanced during manufacture of the crust by flipping the crust after baking (e.g., by 180 degrees) such that the toppings are placed on the side of the crust that was the bottom of the crust during baking. Such flipping can be advantageous because the top of the crust during manufacture tends to be crispier than the bottom because the opposite side can be insulated by the conveyor belt or other apparatus carrying the dough through the oven. Thus, the top of the crust in the oven is directly exposed to the oven heat. Flipping the crust prior to applying toppings results in the top of the crust, which is crispier, becoming the bottom of the crust during product assembly. The toppings are then applied to what was the bottom during the oven heating step. The bread product may then be topped with one or more toppings, if desired. The bread product and any toppings that have been added may then be frozen.

Microwave susceptors are commonly used for heating and crisping food products. Such susceptors typically contain a thin aluminum layer which absorbs microwave energy in a microwave oven, creating electric currents in the aluminum which generate thermal heat in the form of infrared radiation. The generated heat can elevate the temperature of the surface of the susceptor to increase the rate of heating and the crisping of a food product provided on the susceptor. Cooking on a microwave susceptor allows improved heat transfer and provides improved browning and crispiness to the crust. Susceptors useful herein may have one or more layers of metal laminated to paperboard or fluted paperboard of various thicknesses. Generally, a flat dual metal layer susceptor provides more crisping than a flat, single metal layer susceptor. The susceptor may also include metallization patterns, such as metallized or non-metallized dots, stripes, or various other shapes to enhance crisping. Susceptors may also include patterns of cuts, slits, or holes to further enhance crisping by allowing steam venting during cooking. The susceptor may also be in the form of a short platform that provides an elevated cooking surface of about 0.5 to about 1.5 inches for the food product, if desired. Again, such susceptors may include one or more metal layers, and various metallization patterns, slits, and/or holes, if desired.

Bread products of conventional and non-conventional shapes can be formed. Such conventional shapes include, for example, a generally circular, oval square, rectangular (rectangular with one or more rounded ends), and the like, although other shapes may be prepared, if desired. The bread product generally has a thickness of less than about 12 mm thick, preferably about 2 to about 10 mm thick, more preferably about 4 mm to about 8 mm thick, and most preferably about 6 to about 7 mm thick.

In one aspect, the bread product is prepared in the form of a multi-serve pizza crust, and the dimensions of the pizza crust are selected to fit within most standard sized microwaves while still providing the desired organoleptic properties after cooking in the microwaving. For example, prior to the bread products described herein, it was commonly believed that microwaveable pizza products could not be greater than 8 inches in diameter (i.e., single serving sized pizzas) because on non-uniform cooking in microwave ovens. However, the bread products as described herein can be up to about 10 inches in diameter (i.e., multi-serve sized pizzas) and still provide the desired crispy texture to the crust and cooking, but not overcooking, conventional pizza toppings on the crust. Generally, such larger multi-serve sized pizzas as provided herein can be cooked in a microwave in about 5 to about 8 minutes. Of course, cook times may have to be adjusted due to the wattage of the particular microwave used.

In another aspect, the bread product has a low mass to surface area ratio to allow for rapid cooking and superior crisping in the microwave. For example, a bread product having a mass of about 75 to about 125 grams and a total surface area of about 18 to about 25 inches can be cooked on a microwave susceptor to achieve desired crispiness and a surface temperature of at least about 165° F. in about 1.5 minutes to about 3.0 minutes. Even with such large size and short cooking times, the bread products herein have superior crisping when prepared in a microwave oven as compared to prior bread products.

Crispiness can be quantified as the force required to penetrate the crust, such as using a TA-XT2 Texture Analyzer from Texture Technologies Corporation (Scarsdale, N.Y.).

In one aspect, the average force to penetrate the edge of the crust of the bread products described herein is at least about 220 grams. In another aspect, the average force to penetrate the edge of the crust of the bread products described herein is at least about 290 grams. In another aspect, the average force to penetrate the edge of the crust of the bread products described herein is at least about 360 grams.

In another aspect, the average force to penetrate center of the crust of the bread products described herein is at least about 195 grams. In another aspect, the average force to penetrate center of the crust of the bread products described herein is at least about 380 grams. In another aspect, the average force to penetrate center of the crust of the bread products described herein is at least about 485 grams.

In another aspect, the bread product has a weight and surface area such that the bread product can be prepared with full calorie and full fat ingredients (e.g., ingredients that are not classified as reduced fat, low fat, non-fat, reduced calorie, or low calorie) while still providing a lower caloric content per serving. The caloric content to surface area ratio is calculated by dividing the total number of calories (including any toppings) by the surface area of the product. Preferably, the bread products as described herein have a ratio of calories to surface area of about 9.5 or less, more preferably about 8.5 or less when surface area is measured in inches, or about 2.0 or less, more preferably about 1.75 or less when surface area is measured in centimeters. Bread products provided with a thin crust (i.e., less than about 12 mm thick, preferably about 2 to about 10 mm thick, more preferably about 4 mm to about 8 mm thick, and most preferably about 6 to about 7 mm thick) allows for less mass in a larger surface area which also allows for lower caloric content in a larger amount of surface area. For example, a thin crust pizza product having a total mass of 50 to 140 grams and a total surface area of between 13 to 30 square inches may contain less than 200 calories even though full fat toppings are used, such as full fat sauce, cheese and/or meats, are used to prepare the pizza product.

The raw dough may be directly used in baking operations or, alternatively, it may be stored under refrigerated or frozen conditions as a chilled product until used later. The dough may be topped to provide a composite dough product that can be subsequently baked. Depending on the product, the dough may be pre-shaped, baked or par-baked, and topped. The bread product and/or topped bread product may be packaged in any suitable conventional manner for storage and handling.

Preferably, the bread product is frozen after baking. The bread products described herein may be frozen for long term storage. Such bread products are stable at freezing temperatures for at least about 4 months, preferably at least about 6 months, and more preferably at least about 12 months.

If desired, the bread product may be provided with one or more toppings thereon. Generally, the topping is placed on the top of the flatbread using any suitable automatic, semiautomatic, or manual technique. Suitable toppings include, for example, meats (e.g., chicken, turkey, beef, ham, and the like), cheeses, fruits, vegetables, tofu, soy, soy derivatives, and the like as well as combinations thereof. Such toppings may also include sauces, dressings, pesto, spreads, gravies, condiments, spices, flavorings, colorants, and the like as well as combinations thereof. Preferably, meat and/or vegetables in the topping are in the form of lumps or diced shapes.

The meat may be in a shaved, sliced, shredded, chopped, or other convenient form. The type of meat that may be used is not particularly limited. The meat may be beef (e.g., roast beef, barbecued beef, steak, hamburger, etc.); poultry (e.g., chicken breast, barbecued chicken, turkey breast, turkey burger, chicken salad, etc.); pork (e.g., ham, barbecued pork, ham salad, Canadian bacon, etc.); and fish (e.g., tuna, tuna salad, lox, etc.). The meat topping also may be processed meats like bacon, sausage, bologna, olive loaf, pepperoni, salami, corned beef, pastrami, liverwurst, and so forth. Combinations of such meat products may be used if desired. Soy or soy derivative meat substitutes may be used as a protein source in combination with the meat filling, or alternatively in place thereof in the sandwich filling. The water content and water activity of the meat topping may vary greatly depending on the type of meat selected. For instance, leaner cuts of meat generally contain less water content than less lean cuts.

The type of cheese that may be used is not particularly limited. The cheese may be in the form of shredded, sliced, shaved, flaked, powdered, crumbled, slabbed, creamed, and so forth; preferably, the cheese is in the form of cheese shreds. The cheese type, for example, may be process cheese, cheddar cheese, Swiss cheese, American cheese, Provolone cheese, mozzarella cheese, Parmesan cheese, blue cheese, Monterey Jack cheese, Romano cheese, cream cheese, Havarti cheese, Gouda cheese, Muenster cheese, Asiago cheese, feta cheese, Gorgonzola cheese, and combinations thereof. Of course, other cheeses may be used if desired.

Vegetables suitable for use in the filling include, for example, onions, tomato, mushrooms, spinach, bell peppers, hot peppers, garlic, bean sprouts, cucumber, zucchini, potato, kale, basil, and the like as well as combinations thereof. Of course, other vegetables may be used if desired.

Both the bread portion and the topping can be seasoned, such as with salt, pepper, oregano, red pepper flakes or spreads, onion powder, garlic powder, sesame seeds, poppy seeds, cinnamon, and the like as well as combinations thereof. Food additives, such as preservatives, flavorings, colors, emulsifiers, soy flour, and so forth, also can be included in or applied to the dough and/or topping.

All or some of the ingredients in the topping may be premixed if desired; alternatively, all or some of the ingredients may be individually placed on the bread product. All or some of the ingredients in the topping may be frozen or thawed when placed on the bread product. Indeed the entire topping may be prepared and then frozen into the appropriate size and shape (i.e., puck or other shape) and then placed frozen on the bread product. The bread product may also be pre-frozen. The bread product may be frozen before or after the addition of toppings, if used. Conventional freezing techniques are used to freeze the bread product.

The assembled bread product is packaged, preferably using modified atmosphere techniques, frozen (if not already frozen), and then stored under suitable conditions. In one aspect, the bread product is provided as a fully assembled flatbread with toppings thereon and contained in a package that can be opened and then heated directly in a microwave oven.

Alternatively, the frozen bread product and toppings can be provided in a single serve package having separate compartments or pouches for the frozen bread product and various toppings. The pouches preferably are sealed under an inert atmosphere to increase the shelf life of the product or kit.

The frozen bread products may be cooked in a microwave oven. Generally, the bread products can be baked in a microwave oven for about 1.5 to about 9 minutes if the product is topped or for about 30 seconds to about 5 minutes if untopped, depending on the size of the bread product. For example, a bread product having a mass of about 75 to about 125 grams and a total surface area of about 18 to about 25 inches can be cooked on a microwave susceptor to achieve desired crispiness and a surface temperature of at least about 165° F. in about 1.5 minutes to about 3.0 minutes if topped or about 30 seconds to about 2 minutes if untopped. A larger bread product, such as a bread product having a 10 inch diameter, can be baked in a microwave oven for about 5 to 9 minutes if topped or about 1 minute to about 5 minutes if untopped. As one of ordinary skill in the art will readily recognize, the precise cooking conditions will vary depending on the type of microwave oven used and the type and thickness of bread product being made.

The example that follows is intended to illustrate the bread products and not to limit it. All percentages used herein are by weight unless otherwise indicated.

### EXAMPLE

Inventive thin crust pizza products were prepared according to the following formulation:

| Ingredient | Baker's Percentages |
|---|---|
| Wheat flour (from ADM) | 100 |
| Compressed yeast (from Lallemand Inc.) | 4 |
| Encapsulated sodium bicarbonate (from Balchem) | 0.91 |
| Sodium aluminum phosphate (from Astaris LLC) | 0.91 |
| Salt | 2 |
| Sugar | 1 |
| Palm chips (from Golden Brands) | 5 |
| Water | 58 |
| Soybean oil | 4 |

The inventive thin crust pizza were prepared to have a total mass of about 36 grams and a mass to surface area ratio (g/in²) of 4.7. For purposes of comparison, commercially available pizza products, including Red Baron Singles Thin and Crispy Pepperoni Pizzas and Red Baron Flatbread Singles Chicken Parmesan were also analyzed. The Red Baron Singles Thin and Crispy product both had average mass to surface area ratios (g/in²) of 4.6.

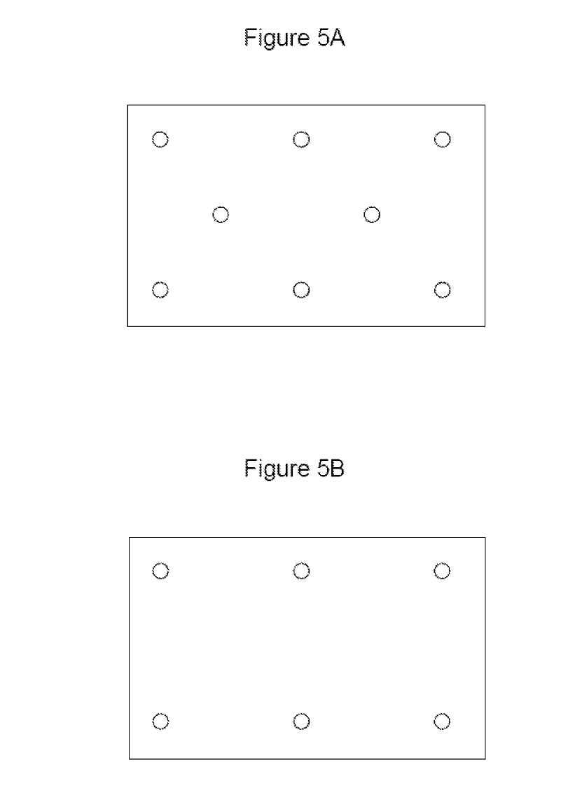

The pizza products were cooked on various trays, with or without a susceptor, in a Sharp R-630DW 1100 watt microwave oven. The trays used included the following: (1) 1 inch elevated tray with single metal layer and one hole in center of tray and a plurality of slits; (2) flat, dual metal layer tray with hole pattern #1 as pictured in FIG. 5(A); (3) flat dual metal layer tray with hole pattern #2 as pictured in FIG. 5B; (3) flat single metal layer tray having hole pattern #2 as pictured in FIG. 5(B); (4) a 6.5 inch by 6.5 inch tray torn in half having 1 inch elevation and a single metal layer surface; (5) susceptor included in Red Baron Thin and Crispy Singles product; and (6) elevated paperboard tray (no susceptor) included with Red Baron Flatbread Singles product.

Product temperatures were measured before and after cooking. A few minutes were typically allowed to pass between cooking products in the microwave oven to allow the oven to cool. After every few cook cycles, the glass turntable in the microwave oven was removed and cooled to room temperature.

The texture of the pizza crusts were analyzed using a TA-XT2 Texture Analyzer within about 5 minutes of removing the pizza crust from the oven. Products were turned upside down or crust-side up and probed in multiple locations defined as the “crust center” and the “crust edge” depending on proximity to the center or edge of the product. Crust crispiness was assumed to be linearly proportional to the average force used to penetrate the crust.

The TA-XT2 Texture Analyzer, which measures force in compression, was used with the following settings:

Pretest speed: 1.0 mm/sec

Test speed: 1.7 mm/sec

Post test speed: 10 mm/sec

Distance: 70% of measure

Load cell: 5 kg

The results of the texture analysis are presented in Table 1 below:

TABLE 1

| | | | Avg. product | | |
|---|---|---|---|---|---|
| | | Microwave | mass to surface | Avg. Force to | Avg. Force to |
| | Tray/Susceptor | Cook Time (in | area ratio | Penetrate Edge | Penetrate |
| Pizza Type | Type | minutes) | (g/in²) | (g) | Center (g) |
| Inventive | 1 inch, single | 1:15 | 4.7 | 220 | 196 |
| | metal layer | | | | |
| | elevated tray | | | | |
| | with one hole in | | | | |
| | center of tray | | | | |
| | and plurality of | | | | |
| | slits | | | | |
| Inventive | Dual metal layer | 1:15 | 4.7 | 294 | 383 |
| | flat with hole | | | | |
| | pattern #1 | | | | |
| Inventive | Dual metal layer | 1:15 | 4.7 | 307 | 452 |
| | flat with hole | | | | |
| | pattern #2 | | | | |
| Inventive | Single metal | 1:15 | 4.7 | 318 | 485 |
| | layer flat with | | | | |
| | hole pattern #2 | | | | |
| Inventive | 6.5 × 6.5 inch | 1:15 | 4.7 | 361 | 355 |
| | tray with 1 inch | | | | |
| | elevation and | | | | |
| | single metal | | | | |
| | layer surface | | | | |
| | torn in half | | | | |
| Inventive | Susceptor tray | 1:25 | 4.7 | 399 | 523 |
| | included in Red | | | | |
| | Baron Thin & | | | | |
| | Crispy product | | | | |
| Red Baron Thin | Susceptor tray | 1:25 | 4.6 | 88 | 107 |
| & Crispy Singles | included with | | | | |
| (Pepperoni) | Red Baron Thin | | | | |
| | & Crispy | | | | |
| | Product | | | | |
| Red Baron | Red Baron | 1:25 | 4.6 | 66 | 105 |
| Flatbread | Flatbread | | | | |
| Singles | Singles elevated | | | | |
| | paperboard tray | | | | |
| | (no susceptor) | | | | |
| | included with | | | | |
| | product | | | | |
| Red Baron Thin | Dual metal layer | 1:25 | 4.6 | 98 | 101 |
| & Crispy Singles | flat with hole | | | | |
| (Pepperoni) | pattern #2 | | | | |

The inventive pizza product had a significantly crispier crust than commercially available pizza products having the same or similar mass to surface area ratios. The inventive pizza products had crusts that were crisp to the bite but not overly tough. The inventive pizza products also achieved additional crust browning during microwave cooking. Even when the Red Baron Thin and Crispy Singles product was cooked on the dual metal layer susceptor with hole pattern #2, the Red Baron product had only marginally more crispiness at the edge of the crust than it did when cooked on a tray lacking a susceptor. The inventive product also had clearly superior crispiness as compared to the Red Baron Thin and Crispy Singles product when using the susceptor tray included with the Red Baron product. Accordingly, the inventive pizza product had superior crispiness regardless of the tray/susceptor used.

While the bread products herein have been particularly described with specific reference to particular process and product embodiments, it will be appreciated that various alterations, modifications, and adaptations may be based on the present disclosure, and are intended to be within the spirit and scope of the disclosed bread products and methods as defined by the following claims.

We claim:

1. A frozen, fully baked or par-baked, thin crust bread product having a top surface, a bottom surface, and an interior portion, the bread product prepared from a dough comprising, in baker's percentages, 100 percent flour having a protein content of less than about 12 percent, about 50 to about 60 percent water, about 0.5 to about 8 percent oil, about 1.0 to about 7 percent leavening agent, and about 2.0 to about 8.0 percent fat flakes,
the fat flakes have a solid fat content of about 45 to about 65 percent at 80° F., a flake thickness less than the thickness of the baked bread product, and are distributed uniformly throughout the dough before baking or par-baking,
the leavening agent comprises yeast, encapsulated chemical leavening base, and leavening acid, and
the bread product has, after being heated from the frozen state to a temperature suitable for consumption in a microwave oven, a crispy texture for the bottom surface, and a thickness of about 2 to about 10 mm.

2. The bread product of claim 1, wherein the bread product has a mass of about 75 to about 125 grams, a total surface area of about 18 to about 25 inches, and a crispiness of at least about 220 grams average force to penetrate an edge of the bread product after microwave cooking for about 1.5 minutes to about 3.0 minutes.

3. The bread product of claim 1, wherein the bread product has a crispiness of at least about 220 grams of average force to penetrate an edge of the bread product and at least about 195 grams of average force to penetrate a center of the bread product after microwave cooking for about 1.5 to about 3.0 minutes.

4. The bread product of claim 1, wherein the bread product includes toppings and has a ratio of calories to surface area of less than about 9.5.

5. The bread product of claim 1, wherein the leavening agent comprises about 0.5 to about 5 percent yeast, 0.25 to about 1.0 percent encapsulated chemical leavening base, and 0.25 to about 1.0 percent leavening acid.

6. The bread product of claim 2, wherein the yeast is compressed yeast, the encapsulated chemical leavening base is sodium bicarbonate and the leavening acid is sodium aluminum phosphate.

7. The bread product of claim 1, wherein the bread product has a thickness of about 4 to about 8 mm.

8. The bread product of claim 1, wherein the dough comprises, in baker's percentages, 100 percent flour, about 55 to about 60 percent water, about 4 to about 6 percent fat flakes, about 3 to about 5 percent oil, and wherein the leavening agent comprise about 0.5 to about 5 percent yeast, 0.25 to about 1.0 percent encapsulated chemical leavening base, and 0.25 to about 1 percent leavening acid.

9. The bread product of claim 1, wherein the fat flakes have a solid fat content of about 50 to about 60 percent at 80° F.

10. The bread product of claim 1, wherein the bread product is a multi-serve sized pizza having a diameter of up to about 10 inches.

11. A process for preparing a fully baked or par baked bread product having a thickness of about 2 to about 10 mm, the method comprising:
mixing, in baker's percentages, 100 percent flour having a protein content of less than about 12 percent, about 50 to about 60 percent water, about 0.5 to about 8 percent oil, and about 1.0 to about 7 percent leavening agent, to form a first dough mixture;
adding about 2.0 to about 8.0 percent fat flakes agent to the first dough mixture and mixing in a manner effective to provide a dough with fat flakes of desired dimensions distributed uniformly throughout the dough, the fat flakes having a solid fat content of about 45 to about 65 percent at 80° F., wherein the desired dimensions include a flake thickness less than the thickness of the baked bread product;
resting the dough;
proofing the dough;
shaping the dough into a desired shape for the bread product;
baking the dough to form a fully baked or par baked bread product having a top side and a bottom side;
freezing the baked bread product, wherein the frozen baked bread product is suitable for heating in a microwave oven before consumption by a consumer to provide a bread product having a crispy texture for the bottom surface.

12. The process of claim 11, wherein the process further comprises flipping the baked bread product after baking and prior to topping the bread product such that the top of the bread product during baking is the bottom of the bread product during topping.

13. The process of claim 11, wherein the bread product is a multi-serve sized pizza having a diameter of up to about 10 inches.

14. The process of claim 11, wherein the bread product has a mass of about 75 to about 125 grams, a total surface area of about 18 to about 25 inches, and a crispiness of at least about 220 grams of average force to penetrate an edge of the bread product and at least about 195 grams of average force to penetrate a center of the bread product after microwave cooking for about 1.5 to about 3.0 minutes.

15. The process of claim 11, wherein a crispiness is about 220 to about 400 grams of average force to penetrate an edge of the bread product and about 195 to about 525 grams of average force to penetrate a center of the bread product after microwave cooking for about 1.5 to about 3.0 minutes.

16. The process of claim 11, wherein the bread product includes toppings and has a ratio of calories to surface area of less than about 9.5.

17. The process of claim 11, wherein the leavening agent comprises about 0.5 to about 5 percent yeast, 0.25 to about 1.0 percent encapsulated chemical leavening base, and 0.25 to about 1.0 percent leavening acid.

18. The process of claim 11, wherein the bread product has a thickness of about 1 to about 5 mm.

19. The process of claim 11, wherein the fat flakes have a solid fat content of about 50 to about 60 percent at 80° F.

20. The process of claim 11, wherein the dough comprises, in baker's percentages, 100 percent flour, about 55 to about 60 percent water, about 4 to about 6 percent fat flakes, about 3 to about 5 percent oil, and wherein the leavening agent comprise about 0.5 to about 5 percent yeast, 0.25 to about 1.0 percent encapsulated chemical leavening base, and 0.25 to about 1.0 percent leavening acid.
